(19) United States
(12) Patent Application Publication
(10) Pub. No.: US 2018/0311734 A1
(43) Pub. Date: Nov. 1, 2018

(54) METHOD FOR THE PRODUCTION OF A SUPPORT STRUCTURE FOR SUPPORTING A THREE-DIMENSIONAL OBJECT TO BE ADDITIVELY MANUFACTURED

(71) Applicant: CL SCHUTZRECHTSVERWALTUNGS GMBH, Lichtenfels (DE)

(72) Inventors: Frank HERZOG, Lichtenfels (DE); Florian BECHMANN, Lichtenfels (DE)

(73) Assignee: CL SCHUTZRECHTSVERWALTUNGS GMBH, Lichtenfels (DE)

(21) Appl. No.: 15/774,100

(22) PCT Filed: Nov. 10, 2016
(86) PCT No.: PCT/EP2016/077229

§ 371 Date: May 7, 2018

(30) Foreign Application Priority Data
Nov. 16, 2015 (DE) 10 2015 119 746.4

(51) Int. Cl. B22F 3/105; B33Y 10/00; B33Y 40/00; B23H 3/00

(52) U.S. Cl. CPC B22F 3/1055; B33Y 10/00; B22F 2003/1058; B23H 3/00; B33Y 40/00

(57) ABSTRACT

The invention concerns a procedure for the manufacture of at least one supporting structure (2) comprising support element (11) for at least sectional support of a generatively formed three-dimensional object (3) on the support structure (2) through generatively configured successive layered selective solidification of built material layers from a solidifiable built material (4), by means of an energy beam (6), with at least one attack structure (12) being configured, on which electrochemical material removal can be initiated or is initiated on at least one support element (11).

### CROSS-REFERENCE TO RELATED APPLICATIONS

This application is a United States national stage entry of an International Application serial no. PCT/EP2016/077229 filed Nov. 10, 2016 which claims priority to German Patent Application serial no. 10 2015 119 746.4 filed Nov. 16, 2015. The contents of these applications are incorporated herein by reference in their entirety as if set forth verbatim.

### DESCRIPTION

The invention concerns a procedure for the manufacture of a support structure comprising at least one supporting element for at least sectional support of a three-dimensional object formed generatively by means of an energy beam through successive layered selective solidification of built material layers from a solidifiable built material.

The use of corresponding support structures—sometimes designated also as supporting structures—is known for support of these generatively formed three-dimensional objects in the context of generative formation of three-dimensional objects.

Corresponding support structures do not represent constituents of the three-dimensional objects to be formed generatively and are removed after completed formation of the generatively formed three-dimensional objects.

Removal of the support structures is currently done purely mechanically and typically requires several mechanical or, where appropriate, even manual work procedures. Automatable removal in a technical processing sense can hardly be realized in a cost-effective way due to the individual or comparatively complex geometrical constructive design of corresponding support structures

The object of the invention demonstrates on the other hand an improved process for the manufacture of a corresponding support structure with respect to an improved procedure for, where appropriate, automatable removal of a manufactured support structure.

The object is fulfilled by a procedure according to the claims. The appurtenant dependent claims concern certain forms of embodiment of the procedure. The object is further fulfilled by a support structure according to the claims.

The procedure described here (initially) serves in general the purpose of manufacturing a support (supporting) structure for at least sectional support, i.e. for support at least of a partial area of an object to be formed generatively in three dimensions on the support structure. The support structure comprises at least one, typically several, support element(s). The support structure or corresponding support elements can take on any desired geometrical form. Individual, several, or all support elements can be the same, resemble, or differ in their respective geometrical form. Corresponding support elements can, for example, take on a longitudinal form—i.e. in the shape of a rod or pole—or a planar, i.e. platelet, form.

The geometrical form of the support structure or support elements is selected in general at least in sections with respect to the geometrical constructive design of the object sections supported by them on the support structure of the generatively configured three-dimensional object (further designated in brief as “object”).

Even though the preferred generative formation of the support structure is primarily described, the support structure to be manufactured according to the procedure can principally also be manufactured by non-generative manufacturing processes, for example, casting processes.

A support structure manufactured according to the procedure—analogously to the object at least sectionally supported by the support structure—by successive layered selective solidification of built material layers generatively formed by means of an energy beam is thus preferred.

The successive selective solidification of built material layers to be solidified is accomplished on the basis of construction data. Corresponding construction data generally describe the geometrical or geometrical constructive form of the support structure to be generatively manufactured or of the object to be generatively formed at least in sections on the support structure. Corresponding construction data can, for example, be CAD data or contain such CAD data of the support structure to be manufactured or the object supporting it at least in sections.

The generative manufacture of the support structure is carried out by means of a device for the generative manufacture of at least one three-dimensional object—that is, for example, of a technical component or of a technical component group through successive layered selective solidification of individual built material layers from a solidifiable built material by means of at least one energy beam produced by an energy beam generator. The device comprises the typically required functional components for carrying out generative construction processes—that is, particularly, a beam generating device for production of an energy beam, in particular a laser or electron beam for successive layered selective solidification of individual built material layers from a solidifiable built material, in particular a metal, plastic, or ceramic powder and a coating device for formation of built material layers on one construction level. The construction level can be the surface of a carrier element of a carrier device typically displaceable (in a vertical direction) or an already solidified built material layer.

An attack structure is configured basically independently of the type of manufacturing on at least one support structure, on which electrochemical or electrical machining from the support structure can be or is initiated from the support structure. Electrochemical or electrical machining of material from the support structure can be carried out by execution of at least one method for electrochemical or electrical machining of material from the support structure. At least one procedure for electrochemical or electrical removal of material from the support structure can be carried out in the context of a procedure for removal of a support structure manufactured in accordance with procedures from a generatively configured or manufactured object.

Electrochemical machining (ECM) and a method for electrochemical removal of material is based on the principle of applying electrical voltage to the element to be removed, specifically to apply electrical voltage to the support structure or corresponding supporting elements of the support structure by means of a source of electrical voltage. The element to be removed can be toggled specifically as a first electrode, for example as the anode, and a removal tool as the opposite electrode, for example as the cathode. The element to be removed and the removal tool are mounted in an electrically conductive electrolyte, for example a salt solution. Between the element to be removed and the removal tool a clearance is typically a configured, for example from 0.01 to 1 mm. Ionic constituents are dissolved by the conduction occurring with the high electrical voltage arising between the element to be removed and the removal tool, at which point the removal of material occurs.

Electrical removal of material and thus a method for electrical removal of material is based on a similar principle, where the element to be removed and the removal tool are not mounted in an electrically conductive electrolyte but rather in a dielectric that is not (or scarcely) an electrically conducting dielectric, for example oil. Removal of material from the element to be removed takes place by means of sparks originating from electrical discharges between the element to be removed and the removal tool.

In both cases the element to be removed has a certain electrical conductivity. The element to be removed is thus typically formed from a metallic built material. The support structure is correspondingly manufactured advantageously from a metallic built material, for example based on aluminum or an aluminum alloy or iron or an iron alloy, particularly steel.

By means of formation of corresponding attack structures on corresponding support elements, which attack structures typically are configured on a free outer side of a support element, electrochemical or electrical removal of material (“electrochemical or electrical attack”) is (preferably) initiated on the support elements of the support structure. Electrochemical or electrical removal of material is preferably carried out on the support structure, where it can be removed in a comparatively simple automatable way that is suitable for series production. An object generatively configured on the support structure will not be or scarcely be affected due to its typically closed and/or small surface.

It is thus a matter of specifying an improved procedure for the manufacture of a corresponding support structure, especially with regard to simple, perhaps automated, removal of a support structure.

As mentioned, the support structure is configured by successive layered selective solidification of built material layers from a solidifiable built material generatively formed by means of an energy beam. An especially efficient embodiment provides that corresponding attack structures are simultaneously configured with the generative formation of the support structure. Generative configuration of corresponding attack structures additionally provides maximum geometrical freedom of design of the attack structures.

In principle, all geometrical design elements come into question as attack structures on which electrochemical or electrical (preferred) removal of material can be initiated in carrying out a corresponding method for removal of material.

Attack structures can in general be configured by means of targeted weakening or strengthening of the cross section of support elements, since a concentration of the electrical field occurs on corresponding “irregularities” on the surface of the support element, which conditions initiation of an electrochemical or electrical attack and favors electrochemical or electrical removal of material. The support elements assure their original support function but also additionally comprise a geometrical form that offers the largest possible attack surface for an electrochemical or electrical attack.

Openings, depressions, projections, and points can, for example, be configured as attack structures or delimiting areas such as openings, depressions, projections, or points and especially edges can be configured on or in corresponding support elements. A certain roughness of the support elements can also be configured as an attack structure. An attack structure can thus be configured by means of regular or irregular three-dimensional surface structuring of a support element. Several geometrically different attack structures can, of course, be configured on one support element.

It is also conceivable that a cellular structure (cell structure), especially a porous cellular structure, can be configured as an attack structure. A support structure or a support element can thus at least in sections be manufactured especially with a porous cellular structure (foam structure) that is wettable or permeable by a fluid working medium, for example an electrolyte or a dielectric. The support elements or attack structures are formed here by the cellular structure of the wall elements.

The invention further concerns a support structure manufactured according to the previously mentioned procedure for at least sectional support of a three-dimensional object configured generatively. All embodiments are consequently valid analogously for the support structure in connection with the method for the manufacture of the support structure.

The invention further concerns a procedure for the generative manufacture of at least one three-dimensional object by successive layered selective solidification of built material layers of a solidifiable built material by means of an energy beam. The procedure is characterized in that—in the first stage—generative formation of at least one support structure comprising a support element for at least sectional support of a three-dimensional object is configured generatively, especially according to the procedure described above, whereby the support structure is generatively configured through successive layered selective solidification of built material layers from a solidifiable built material, with an attack structure on at least one support element being configured on which removal of material is initiable or is initiated. In an implementable or implemented further step simultaneously with the first step, generative configuration of the object to be manufactured is carried out, with at least one subsection of the object on the support structure being configured.

Since a corresponding support structure is configured or manufactured in the context of the procedure for the manufacture of a three-dimensional object, all embodiments concerning manufacture of three-dimensional objects, especially their generative configuration or manufacture, are analogous in connection with the procedure for the manufacture of the support structure.

The support structure and the object are advantageously configured or manufactured at least in sections, in particular completely, from the same, in particular metallic, solidifiable built material. The at least sectional, in particular complete, configuration of the support structure and of the object from the same built material considerably facilitates the generative construction process or the accompanying preparatory and follow-up processes like supply of the built material to be solidified into a construction or processing chamber or the removal or recycling or reuse of non-solidified built material from a construction or processing chamber. Corresponding metallic built materials are, as mentioned, aluminum or aluminum alloys or iron or iron alloys, particularly steel.

To the extent that objects manufactured should comprise several separate object sections, the support structure can at least in sections be configured between a first object section and at least a further object section. The minimally two object sections can, for example be configured next to each other on an arbitrary spatial axis, i.e. be configured on a vertical axis above each other.

The first object section can be configured with at least a first interlocking element, for example a projection, and a further object section with at least one interlocking element corresponding to the first formation closure element (counter interlocking element), for example a depression, whereby the supporting structure can be configured between the first and the further object section, so that the respective interlocking elements interact with each other after removal of the supporting structure with formation of an interlocking connection with each other, i.e. grip into each other. A corresponding interlocking connection can enable a certain displaceability of object sections relative to each other.

The invention further concerns a procedure for the manufacture of a three-dimensional object according to the foregoing for the manufacture of a three-dimensional object. All embodiments are analogously valid for the three-dimensional object in connection with the procedure for the manufacture of a three-dimensional object.

Beyond this, the invention concerns a procedure for removal of a support structure manufactured according to the procedure for the manufacture of a support structure from a manufactured three-dimensional object according to the procedure for the manufacture of a three-dimensional object. The procedure is characterized in that at least one method for electrochemical or electrical removal of material from the support structure is carried out, at which point electrochemical or electrical (preferred) removal of material is initiable or initiated on at least one attack structure.

Since the procedure serves for removal of a correspondingly manufactured support structure, all embodiments are consequently valid analogously in connection with the procedure for the manufacture of the support structure.

The method for electrochemical removal of material can in particular be an automatable or automatic electrochemical removal process. The current strength (per surface) applied here can be, for example, in the range between 0.1 and 5 A/mm². The method for electrochemical removal of material can in particular be an automatable or automatic electrochemical removal process, in particular a spark erosion process. The current strength (per surface) applied for it can also be, for example, in the range between 0.1 and 5 A/mm².

The support structure can be either completely removed or only partially removed by the procedure for electrochemical or electrical removal of material. In the latter instance, a remaining part of the support structure after partial removal, which can also be a weakening of the support structure, can be removed by means of a separate, for example mechanical and/or radiation-based, removal of material. In this fashion—for example through chronological and/or reduced implementation of the procedure for controllable intensity of removal, for example by means of the selected electrical voltage, which presupposes only partial removal of the support structure—it may be ensured that removal of material from the object is not caused by this method.

The invention is explained in more detail in the exemplary embodiments in the drawings. The following are shown:

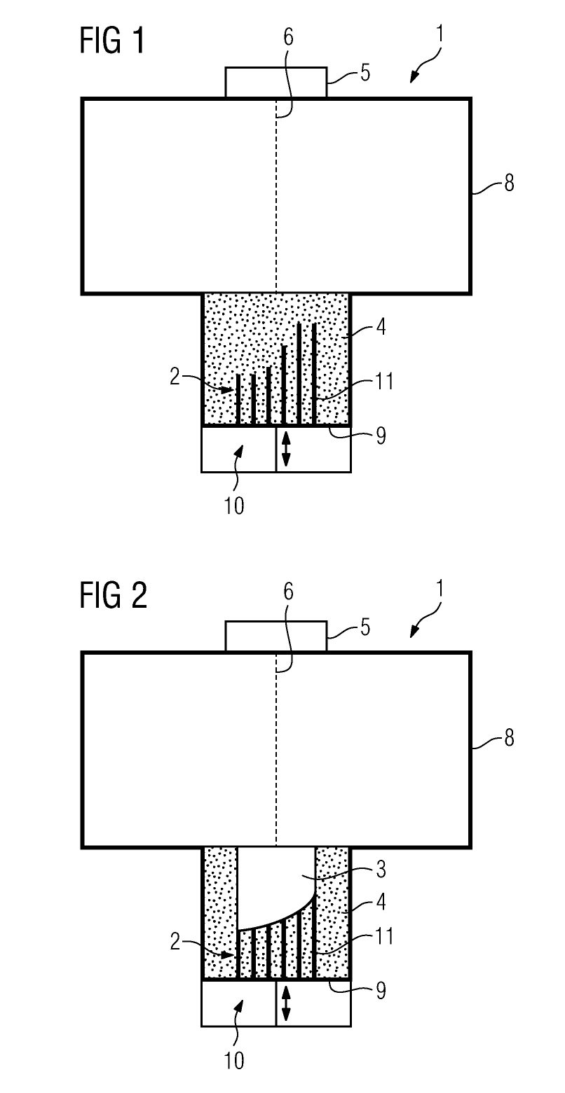

FIGS. 1-3 a schematic diagram of a device for carrying out a procedure for the manufacture of a support structure according to an exemplary embodiment and

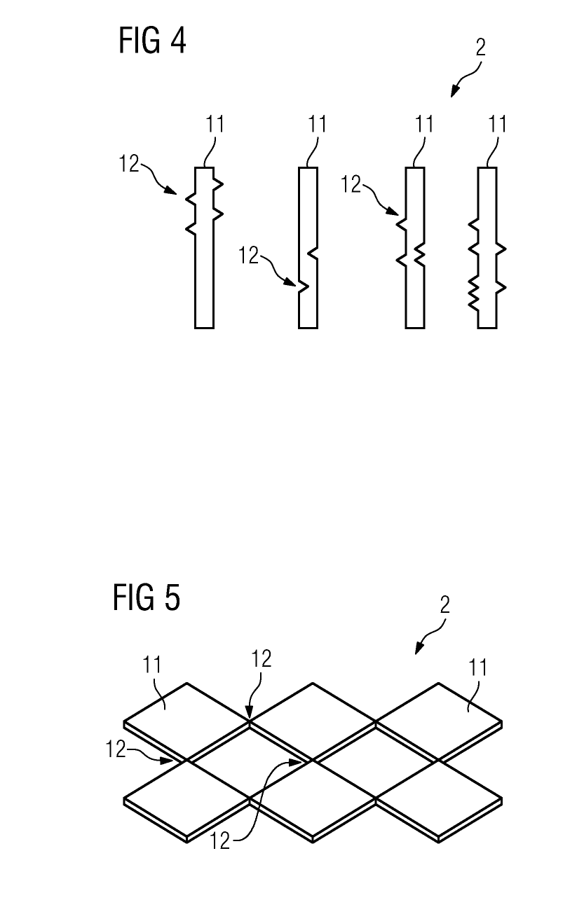

FIGS. 4-5 a schematic diagram of a support structure according to an exemplary embodiment.

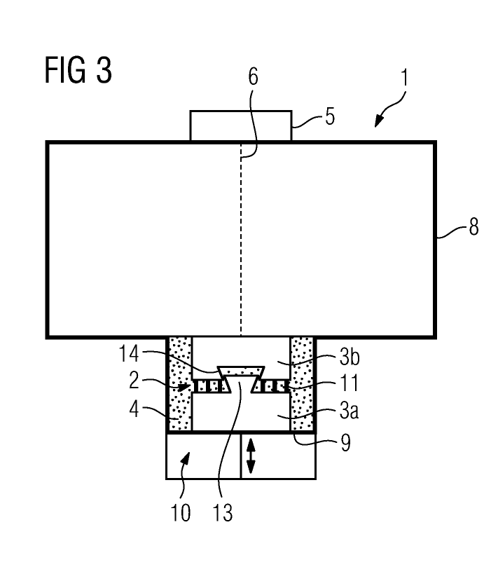

FIG. 1 shows a schematic diagram of a device 1 for carrying out a procedure for the manufacture of a support structure 2 for at least sectional support, i.e. for support of at least one partial area of a three-dimensional object 3 to be generatively formed on support structure 2. (Cf. FIGS. 2, 3).

Device 1 serves both the generative manufacture of the support structure 2 through selective solidification of built material layers from a solidifiable built material 4 by means of an energy beam 6 produced by beam generator device 5 and also the generative manufacture of an object 3 supported at least in sections by support structure 2, i.e. typically of a technical component or a technical component group though selective solidification of built material layers from one or a certain solidifiable built material 4 by means of one of the energy beams 6 produced by beam generator device 5.

The successive selective solidification of built material layers is accomplished on the basis of construction data. Corresponding construction data generally describe the geometrical or geometrical constructive form of the support structure 2 to be generatively manufactured or of the object 3 to be generatively formed at least in sections on the support structure 2. Corresponding construction data can, for example, contain CAD data of the support structure 2 to be manufactured or be data of the object 3 or contain such CAD data.

The selective solidification of a built material layer to be solidified by the displaceably mounted coating device 7, as the horizontally oriented arrow indicates, is carried out in that the energy beam 6, produced by the radiation generation device 5 or by means of a beam deflector or scanner device (not shown), is directed selectively on certain layered cross-sectional geometries to be solidified of the generatively manufactured support structure 2 of the generatively manufactured object 3. The construction level can be the already solidified built material layer or the surface or upper side of a typically displaceable (in a vertical direction) carrier element 9 of a carrier device 10.

The formation and selective solidification of built material layers takes place in a construction chamber 8 of device 1. An inert gas atmosphere typically prevails in the construction chamber 8, that is, for example, an argon or nitrogen atmosphere.

The energy beam 6 produced by the radiation generation device 5 is electromagnetic radiation, i.e. a laser beam or, in brief, a laser. The radiation generation device 5 is a laser generation device for production of a laser beam. The device 1 can thus be a selective laser sintering device, i.e. SLS device, for carrying out selective laser sintering processes for the generative manufacture of three-dimensional objects or a selective laser melting device, i.e. SLM device, for carrying out selective laser melting processes for the generative manufacture of three-dimensional objects.

The solidifiable built material 3 is a solidifiable metal powder, i.e. an aluminum powder or a steel powder, that can be solidified by means of energy beam 6.

The manufactured support structure 2 producible or produced by device 1 comprises several support elements 11 of a determined geometrical form. Individual, several, or all support elements 11 can be the same, resemble, or differ in their respective geometrical form. The exemplary embodiments shown in FIGS. 1-4 show support elements 11 to have a longitudinal, i.e. a rod-formed or stick-formed geometrical form. In the exemplary embodiment shown in FIG. 5 the support elements 11 have a flat, i.e. platelet, form.

The geometrical form of the support structure 2 or support elements 11 is in general selected with regard to the geometrical constructive design of the object sections to be supported of object 3 formed generatively on the support structure 2 (cf. FIG. 2). The support structure 2 forms one part of the outer contour of object 3.

An attack structure 12 is configured in the context of the generative formation of support structure 2 on one, multiple, or all support elements 11, from which electrochemical or electrical removal of material from the support structure 2 can be or is initiated. Electrochemical or electrical removal of material from the support structure 2 is carried out by execution of at least one method for electrochemical or electrical removal of material from the support structure 2. Carrying out at least one method for electrochemical or electrical removal of material from the support structure 2 can be carried out in the context of a procedure for removal of a support structure 2 from an object 3.

Electrochemical removal of material and thus a method for electrochemical removal of material is based on the principle of applying electrical voltage by means of a source of electrical voltage to the support structure 2 or to the corresponding support elements 11 of support structure 2 to be removed. The support structure 2 can be toggled specifically as a first electrode, for example as the anode, and a removal tool as the opposite electrode, for example as the cathode. The support structure 2 and the removal tool are mounted in an electrically conductive electrolyte, for example a salt solution. Between the support structure 2 and the removal tool a clearance is typically configured, for example from 0.01 to 1 mm. By means of the current flow originating from the correspondingly higher electrical voltage, for example in a range of 0.1 to 5 A/mm², between the support structure 2 and the removal tool, ionic components are dissolved from support structure 2, at which point removal of material from support structure 2 occurs.

Electrical removal of material and thus a method for electrical removal of material based on a similar principle, with the support structure 2 and the removal tool to be removed being placed not in an electrically conductive electrolyte but rather in a dielectric that is not (or scarcely) an electrically conducting dielectric, for example oil. Removal of material from the support structure 2 and the removal tool takes place by means of sparks originating from electrical discharges between the support structure 2 to be removed and the removal tool.

For both cases a certain conductivity of the support structure 2 is required, for which reason the support structure 2 is formed of a metallic built material.

By means of formation of corresponding attack structures 12 on support elements 11, which attack structures 12 are typically configured on a free outer side of a support element 11, electrochemical or electrical removal of material (“electrochemical or electrical attack”) is initiated on the support elements 11 of the support structure 2. Electrochemical or electrical removal of material is preferably carried out on the support structure 2, where it can be removed in a comparatively simple automatable way, which is suitable for series production. An object generatively configured on the support structure 2 will not be or scarcely be affected due to its typically closed and/or small surface.

Corresponding attack structures 12 are typically simultaneously configured with generative formation of the support structure 2. Generative configuration of corresponding attack structures 12 additionally provides maximum geometrical freedom of design of the attack structures 12.

Basically all geometrical design elements come into question as attack structures 12 on which electrochemical or electrical removal of material is initiated in carrying out a corresponding method for electrochemical or electrical (preferred) removal of material.

It can be seen from FIGS. 4, 5 that attack structures 12 can in general be configured by means of targeted weakening or strengthening of the cross section of support elements 11, since a concentration of the electrical field occurs on corresponding “irregularities” on the surface of the support element, which conditions initiation of an electrochemical or electrical attack and favors electrochemical or electrical removal of material. The support elements 11 assure their original support function but also additionally comprise a geometrical form that offers the largest possible attack surface for an electrochemical or electrical attack.

It can be seen from FIG. 4 that as corresponding attack structures 12 openings, depressions, projections, and points can, for example, be configured or delimiting areas such as openings, depressions, projections, or points and especially edges can be configured on or in corresponding support elements 11. An attack structure 12 can thus be configured by means of determined regular or irregular three-dimensional surface structuring of a support element 11.

It can be seen from FIG. 5 that with a flat support structure 2 as a corresponding attack structure 12 connection areas or connection paths can be configured between individual, here platelet-formed, support elements 11.

Even if not shown in the Fig., it is also possible that a support structure 2 or a support element 11 can thus at least in sections be manufactured especially with a porous cellular structure (foam structure) that is wettable or permeable by a fluid working medium, for example an electrolyte or a dielectric. The support elements 11 or attack structures 12 are formed here especially by the cellular structure forming the wall elements.

In the exemplary embodiment shown in FIG. 2 the generative formation or manufacture of an object 3 is shown on a support structure 2. In general, the exemplary embodiment shown in FIG. 2 is a procedure for the generative manufacture of a three-dimensional object 3 by successive layered selective solidification of built material layers of a solidifiable built material 4 by means of an energy beam 6. The procedure is characterized in that, in the first stage, generative formation of at least one support structure 11 comprising a support element 2 for at least sectional support of an object 3 is configured generatively, whereby the support structure 2 is generatively configured through successive layered selective solidification of built material layers from a solidifiable built material 4 by means of energy beam 6, whereby an attack structure 12 on at least one support element 11 is configured on which electrochemical removal of material is initiable or is initiated. Generative configuration of the object 3 to be manufactured is carried out in a further step, possibly simultaneously with the first step, whereby at least one subsection of the object 3 is configured on the support structure 2.

The support structure 2 and the object 3 are advantageously configured or manufactured from the same solidifiable built material 4. Complete configuration of the support structure 2 and of the object 3 from the same built material 4 considerably facilitates the generative construction process or the accompanying preparatory and follow-up processes like supply of the built material 4 to be solidified into a construction chamber 8 or the removal or recycling or reuse of non-solidified built material 4 from a construction chamber 8.

On the basis of the exemplary embodiment shown in FIG. 3, it is apparent that a manufactured object 3 can comprise multiple discrete object sections 3a, 3b. In this case the support structure can be configured at least in sections between a first object section 3a and a further object section 3b. In the exemplary embodiment shown in FIG. 3 the object sections 3a, 3b are located next to each other or above each other with regard to a spatial axis, here a vertical axis.

The lower first object section 3a in FIG. 3 is configured with an interlocking element 13 in the shape of an undercut projection in the exemplary embodiment. The further upper object section 3b in the Fig. is configured in the exemplary embodiment with the corresponding interlocking element 14 (counter interlocking element) in the form of an undercut depression. The supporting structure 2 is configured between the first object section 3a and the further object section 3b, so that the respective interlocking elements 13, 14 interact with each other after removal of the supporting structure 2 with formation of an interlocking connection with each other, i.e. gripping each other. A correspondingly configured interlocking connection can enable a certain displaceability of object sections 3a, 3b relative to each other.

It holds for all exemplary embodiments that a procedure is implemented for removal of support structure 2 from an object 3. The procedure is characterized in that at least one method for electrochemical or electrical removal of material from the support structure 2 is carried out, at which point electrochemical or electrical (preferred) removal of material is initiable or initiated on at least one attack structure 12.

The method for electrochemical removal of material can in particular be an automatable or automatic electrochemical removal process. The current strength (per surface) applied here can be, for example, in the range between 0.1 and 5 A/mm². The method for electrochemical removal of material can in particular be an automatable or automatic electrochemical removal process, in particular a spark erosion process. The current strength (per surface) applied for it can also be, for example, in the range between 0.1 and 5 A/mm².

The support structure 2 can be either completely or partially removed through the procedure for electrochemical or electrical removal of material. In the latter case after partial removal, by which weakening of support structure 2 occurs, the remaining part of support structure 2 can be removed by means of, for example, mechanical and/or radiation-based, discrete removal of material. In such a way—for example through chronological and/or reduced implementation of the procedure for controllable intensity of removal, for example by means of the mentioned electrical voltage, which presupposes only partial removal of the support structure 2—it may be ensured that removal of material from the object is not caused by this method.

### REFERENCE NUMBER LIST

1 Device
2 Support structure
3 Object
3a, 3b Object section
4 Built material
5 Device for beam generation
6 Energy beam
7 Coating device
8 Construction chamber
9 Carrier element
10 Carrier device
11 Support element
12 Attack structure
13 Form closure element
14 Form closure element

1. A process for the manufacture of a support structure (2) comprising at least one supporting element (11) for at least sectional support of a three-dimensional object (3) formed generatively on the support structure (2) by means of an energy beam (6) through successive layered selective solidification of built material layers from a solidifiable built material (4) characterized in that at least one attack structure (12) is configured on at least one support element (11) and on which structure electrochemical material removal is possible to initiate or is initiated.

2. A process according to claim 1 characterized in that the support structure (2) is generatively configured by means of an energy beam (6) through successive layered selective solidification of built material layers from a solidifiable built material (4).

3. A process according to claim 1 characterized in that the minimum one attack structure (12) is generatively configured, in particular simultaneously with the generative manufacture of the support structure (2).

4. A process according to claim 1 characterized in that at least one opening and/or at least one recess and/or at least one projection on or in a supporting element (11) is configured as an attack structure (12).

5. A process according to claim 1 characterized in that a cell structure, especially an open-pore cell structure, is configured as an attack structure (12).

6. A process according to claim 1 characterized in that the support structure (2) is configured from a metallic material.

7. A support structure (2) for at least sectional support of a three-dimensional object (3) to be configured on said structure, characterized in that it is manufactured according to a process according to claim 1.

8. A process for the generative manufacture of a three-dimensional object (3) by successive layered selective solidification of built material layers of a solidifiable built material (4) by means of an energy beam (6), characterized by the following steps:
Configuration of a support structure (2) comprising at least one supporting element (11) for at least sectional support of the three-dimensional object (3) to be formed generatively on it, especially according to a process according to claim 2, whereby the support structure (2) is generatively configured through successive selective solidification of built material layers from a solidifiable built material (4), with an attack structure (12) being configured on at least one support element (11), and on which structure electrochemical material removal can be initiated or is initiated generatively by means of an energy beam (6),
Generative configuration of the three-dimensional object (3) to be manufactured, with at least one section of the three-dimensional object (3) being configured on the support structure (2).

9. A process according to claim 8 characterized in that the support structure (2) and the three-dimensional object (3) are manufactured at least in sections, in particular completely, from the same, in particular metallic, solidifiable built material (4).

10. A process according to claim 8 characterized in that the support structure (2) is configured at least in sections between a first object section (3a) and at least one further object section (3b)

11. A process according to claim 10 characterized in that the first object section (3a) is configured with at least a first interlocking element (13) and is configured with a further object section (3b) with at least an interlocking element (14) corresponding to the first interlocking element (13), with the support structure (2) being configured between the first and the further object section (3a, 3b), so that the respective interlocking elements (13, 14) interact with each other after removal of the support structure (2) with formation of an interlocking connection with each other.

12. A process according to claim 9 characterized in that at least the one attack structure (12) is generatively configured in particular simultaneously with the generative manufacture of the support structure (2).

13. A process according to claim 9 characterized in that at least one opening and/or at least one indentation and/or at least one, in particular pointed, projection on or in a supporting element (11) is configured as an attack structure (12).

14. A process according to claim 9 characterized in that an especially open-pore cell structure is configured as an attack structure (12).

15. A three-dimensional object (3) characterized in that it is manufactured as per a process according to claim 9.

16. A process for removal of a support structure (2) manufactured from a three-dimensional object (3), the process comprising at least one supporting element (11) for at least sectional support of a three-dimensional object (3) formed generatively on the support structure (2) by means of an energy beam (6) through successive layered selective solidification of built material layers from a solidifiable built material (4) characterized in that at least one attack structure (12) is configured on at least one support element (11) and on which structure electrochemical material removal is possible to initiate or is initiated;
the three-dimensional object (3) being manufactured according to claim 8 characterized in that at least one method for electrochemical or electrical removal of material from the support structure (2) is carried out, with electrochemical or electrical removal of material being initiable or initiated on at least one attack structure (12).

17. A process according to claim 16 characterized in that one method for electrochemical removal comprises an especially automated, electrochemical removal process and the method comprises an especially automated, electrical removal process, especially a spark erosion process, for electrical removal of material.

18. A process according to claim 16 characterized in that the support structure (2) is completely removed by a method for an electrochemical or electrical removal of material or the support structure (2) is only partially removed by the method for electrochemical or electrical removal of material, and in that after said partial removal, remaining parts of the support structure (2) are removed by mechanical-based or radiation-based removal of material.
